(19) United States
(12) Patent Application Publication
(10) Pub. No.: US 2010/0182203 A1
(43) Pub. Date: Jul. 22, 2010

(54) BROADBAND ANTENNA FOR WIRELESS COMMUNICATIONS

(75) Inventor: Shie Ping Terence See, Singapore (SG)

Correspondence Address: AXIS INTELLECTUAL CAPITAL PTE., LTD., 21/21A DUXTON ROAD, SINGAPORE, 089487, SG

(73) Assignee: Agency for Science, Technology and Research, Singapore (SG)

(21) Appl. No.: 12/452,188

(22) PCT Filed: Jun. 19, 2008
(86) PCT No.: PCT/SG2008/156429

§ 371 Date: Feb. 11, 2010

Related U.S. Application Data
(60) Provisional application No. 60/929,245, filed on Jun. 19, 2007.

(51) Int. Cl. H01Q 1/38; H01P 11/00

(52) U.S. Cl. 343/700 MS; 29/600

(57) ABSTRACT

An antenna formable on a ground plane for wireless communications is disclosed. The antenna has a first structure spatially displaced from a ground plane. The antenna also has a second structure coupled to the first structure and extending away from the ground plane. The antenna further has a third structure configured for disposing at least a portion of the first structure between the third structure and the ground plane, the third structure being grounded to the ground plane and being spatially displaced from the second structure, the second structure and the third structure being inter-configured for electromagnetic coupling therebetween for forming a magnetic loop. More specifically, electromagnetic field generated by the first structure and the second structure electromagnetically couples the third structure for inducing generation of broadband electromagnetic waves from the first, second and third structures.

### CROSS-REFERENCE TO RELATED APPLICATION

This application claims the benefit of U.S. provisional application Ser. No. 60/929,245, filed Jun. 19, 2007 and entitled “A Broadband Antenna Apparatus” incorporated herein by reference in its entirety.

### FIELD OF INVENTION

The invention relates generally to antennas. In particular, it relates to a broadband antenna for wireless communications.

### BACKGROUND

The use of broadband technology is becoming increasingly popular in wireless communication systems. In particular, broadband technology is used in multi-band applications to support WLAN, WiFi, WiMAX and UWB standards. Separate antennas are typically required for each of the WLAN, WiFi, WiMAX and UWB applications, as well as separate corresponding circuitries for supporting the applications.

Additionally, there is an increasing demand for smaller and portable broadband wireless communication systems. This means that the antennas and corresponding circuitries of conventional wireless communication systems are required to have smaller dimensions in order to facilitate the miniaturization of such systems.

However, conventional wireless communication systems either do not support multiband applications or are not sufficiently miniaturized for such systems to be portable.

There is therefore a need for a broadband antenna that is dimensionally small and is capable of supporting multi-band applications for use in small portable broadband systems.

### SUMMARY

Embodiments of the invention are disclosed hereinafter for broadband applications having a small dimensional size and capable of supporting multi-band applications for use in small portable broadband systems.

In accordance with a first embodiment of the invention, there is disclosed an antenna formable on a ground plane for wireless communications. The antenna has a first structure spatially displaced from a ground plane. The antenna also has a second structure coupled to the first structure and extending away from the ground plane. The antenna further has a third structure configured for disposing at least a portion of the first structure between the third structure and the ground plane, the third structure being grounded to the ground plane and being spatially displaced from the second structure, the second structure and the third structure being inter-configured for electromagnetic coupling therebetween for forming a magnetic loop. More specifically, electromagnetic field generated by the first structure and the second structure electromagnetically couples the third structure for inducing generation of broadband electromagnetic waves from the first, second and third structures.

In accordance a second embodiment of the invention, there is disclosed a method for configuring an antenna formable on a ground plane for wireless communications. The method involves spatially displacing a first structure from a ground plane. The method also involves coupling a second structure to the first structure and extending the second structure away from the ground plane. The method further involves configuring a third structure for disposing at least a portion of the first structure between the third structure and the ground plane, the third structure being grounded to the ground plane and being spatially displaced from the second structure, the second structure and the third structure being inter-configured for electromagnetic coupling therebetween for forming a magnetic loop. More specifically, electromagnetic field generated by the first structure and the second structure electromagnetically couples the third structure for inducing generation of broadband electromagnetic waves from the first, second and third structures.

In accordance with a third embodiment of the invention, there is disclosed an antenna array for wireless communications. The antenna array has a body having a plurality of surfaces and a plurality of antennas formed on the surfaces of the structure. Each of the plurality of antennas comprises a first structure spatially displaced from a ground plane and a second structure coupled to the first structure and extending away from the ground plane. Each of the plurality of antennas further has a third structure configured for disposing at least a portion of the first structure between the third structure and the ground plane, the third structure being grounded to the ground plane and being spatially displaced from the second structure, the second structure and the third structure being inter-configured for electromagnetic coupling therebetween for forming a magnetic loop. More specifically, electromagnetic field generated by the first structure and the second structure electromagnetically couples the third structure for inducing generation of broadband electromagnetic waves from the first, second and third structures.

### BRIEF DESCRIPTION OF DRAWINGS

Embodiments of the invention are described in detail hereinafter with reference to the drawings, in which:

FIG. 1 shows a perspective view of an antenna having a shorting wall, radiator and feed plate structure according to a first embodiment of the invention;

FIG. 2 shows a plan view of the antenna of FIG. 1;

FIG. 3 shows a side view of the antenna of FIG. 1;

FIG. 4 shows side views of the antenna of FIG. 1, including exemplary configurations of the feed plate structure according to other embodiments of the invention;

FIG. 5 is a graph showing measured return loss characteristic of the antenna of FIG. 1;

FIGS. 6a to 6c are graphs showing measured radiating patterns of the antenna of FIG. 1 at 5.25 GHz, 5.6 GHz, and 5.8 GHz respectively; and

FIG. 7 shows an antenna array for providing an omni-directional coverage in a desired plane.

### DETAILED DESCRIPTION

With reference to the drawings, embodiments of the invention involving an antenna are described for broadband applications having a small dimensional size and capable of supporting multi-band applications for use in small portable broadband systems.

For purposes of brevity and clarity, the description of the invention is limited hereinafter to broadband applications. This, however, does not preclude embodiments of the invention from other applications that require similar operating performance as the broadband applications. The functional principles fundamental to the embodiments of the invention remain the same throughout the various embodiments.

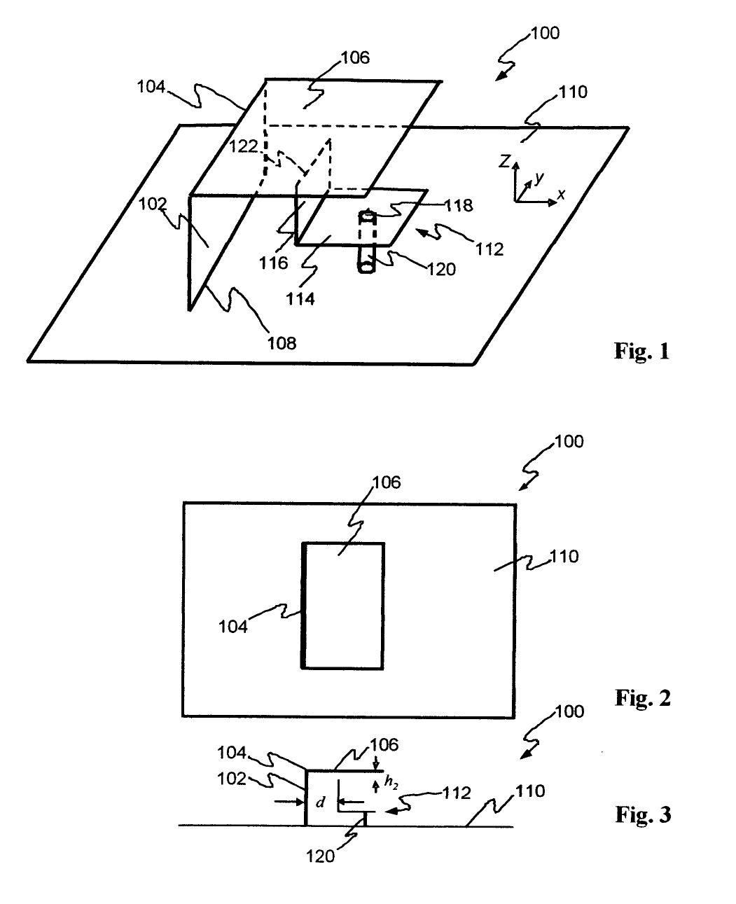

Embodiments of the invention are described in greater detail in accordance with FIGS. 1 to 7 of the drawings hereinafter, wherein like elements are identified with like reference numerals.

FIG. 1 shows a perspective view of an antenna 100 according to a first embodiment of the invention. The following description of the antenna 100 is made with reference to an x-axis, a y-axis and a z-axis of a three-dimensional coordinate system. The x and y axes extend along a ground plane 110 and are coincident therewith.

The antenna 100 comprises structures that are interconnected and inter-displaced for supporting applications in high gain broadband wireless communications. Specially, the antenna 100 comprises a shorting wall 102 formed substantially along the yz-plane. The shorting wall 102 has a first edge 104 that is attached to a radiator 106. The radiator 106 is formed substantially parallel to the xy-plane and is connected along the first edge 104 of the shorting wall 102. This means that the radiator 106 and the shorting wall 102 are substantially parallel and perpendicular to the ground plane 110 respectively.

The shorting wall 102 has a second edge 108 that is opposite to the first edge 104. Additionally, the shorting wall 102 is connected to the ground plane 110 along the second edge 108 substantially parallel to the y-axis. In other words, the second edge 108 and the radiator 106 are electrically shorted to ground via the ground plane 110 during operation of the antenna 100.

Each of the shorting wall 102 and the radiator 106 is preferably plate-like and has a rectangular shape. The shorting wall 102 is alternatively replaceable with shorting pins (not shown) for supporting the radiator 106. The shorting wall 102 allows the radiator 106 to be miniaturizes.

The antenna 100 further comprises a feed plate structure 112. The feed plate structure 112 excites the radiator 106 during operation of the antenna 100. The feed plate structure 112 comprises a first portion 114 formed substantially parallel to the xy-plane and a second portion 116 substantially parallel to the yz-plane. The second portion 116 is arranged substantially perpendicular to the first portion 116. Specifically, the second portion 116 extends from one edge of the first portion 114 that is proximal the shorting wall 102 towards the radiator 106. The first and second portions 114, 116 of the feed plate structure 112 are also known as the first and second structures of the antenna 100, respectively.

Alternatively, the second portion 116 extends from another edge of the first portion 114 that is distal the shorting wall 102. The first portion 114 and the second portion 116 are preferably plate-like and are arranged to form an L-shaped feed plate structure 112.

More specifically, the feed plate structure 112 is preferably formed, but not limited to, within a space created by the radiator 106 and the ground plane 110.

The first portion 114 of the feed plate structure 112 has a feed point 118. A feeding probe 120 is connected to the first portion 114 of the feed plate structure 112 at the feeding point 118. The feed plate structure 112 is suspended above the ground plane 110 at one end of the feeding probe 120. The other end of the feeding probe 120 is connected through the ground plane 110 to a radio frequency connector (not shown). The feeding probe 120 is preferably a 50Ωco-axial probe.

FIGS. 2 and 3 show a plan view and a side view of the antenna 100 respectively. With reference to FIG. 3, the feed plate structure 112 is spaced apart from the shorting wall 102 and the radiator 106. In particular, the second portion 116 of the feed plate structure 112 and the shorting wall 102 are substantially parallel to each other and are separated by a distance d.

With reference to FIG. 3, the second portion 116 of the feed plate structure 112 has a free edge 122 that extends along a direction substantially parallel to the y-axis distal to the first portion 114. The separation or gap between the free edge 122 of the second portion 116 and the radiator 106 is h₂.

Each of the radiator 106, shorting wall 102, and the first and second portions 114, 116 of the feed plate structure 112 has a geometrical shape such as rectangular, triangular, elliptical, semi-elliptical or other polygonal shapes. The radiator 106 and shorting wall 102 are also known as the third and fourth structures of the antenna 100, respectively.

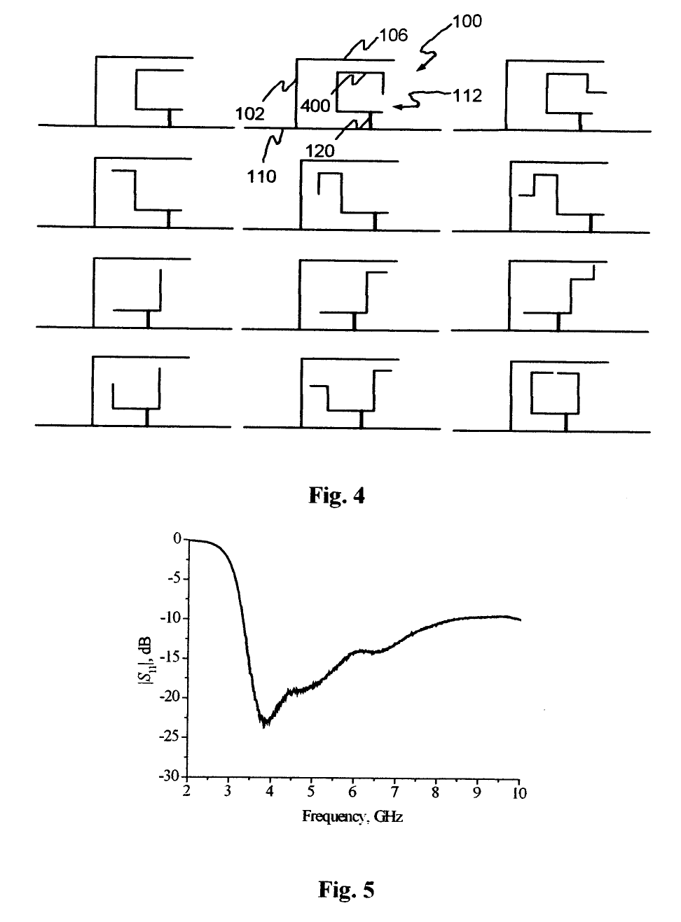

FIG. 4 shows other embodiments of the invention and side views of exemplary configurations of the feed plate structure 112. Additional portions 400 are shown to extend from one or both free edges of the first and second portions 114, 116 of the feed plate structure 112. The additional portions 400 are preferably a plurality of plates sequentially inter-coupled. The second portion 116 preferably has a rectilinear shape.

The electromagnetic coupling between the radiator 106 and the feed plate structure 112, especially between the free edge 122 of the second portion 116 and the radiator 106 for forming a magnetic loop therebetween, allows the antenna 100 to be used for broadband applications. The presence of the first portion 114 of the feed plate structure 112 increases the capacitance at the feed point 118. This is to compensate for the increase in inductance at the feed point 118 necessary for broad bandwidth operation. The manufacturing tolerance of the antenna 100 is advantageously high due to the broadband design.

FIG. 5 is a graph showing measured return loss |S₁₁| characteristic of the antenna 100. The antenna 100 is capable of operating within a bandwidth of 3.5 GHz to more than 10 GHz for |S₁₁| less than −10 dB. In addition, the antenna 100 has a well-matched impedance matching characteristic within a bandwidth of 5 GHz to 6 GHz for |S₁₁| less than −14 dB.

As shown in FIG. 5, the antenna 100 has a well-matched impedance matching characteristic to cover frequency bands of 5.15 to 5.35 GHz, 5.47 to 5.73 GHz and 5.73 to 5.88 GHz bands for |S₁₁| less than −14 dB. This means that the antenna 100 is capable of supporting multi-band operation for each of WLAN, WiFi, WiMAX and UWB standards and thereby advantageously eliminates the need for separate antennas and corresponding base band circuitries.

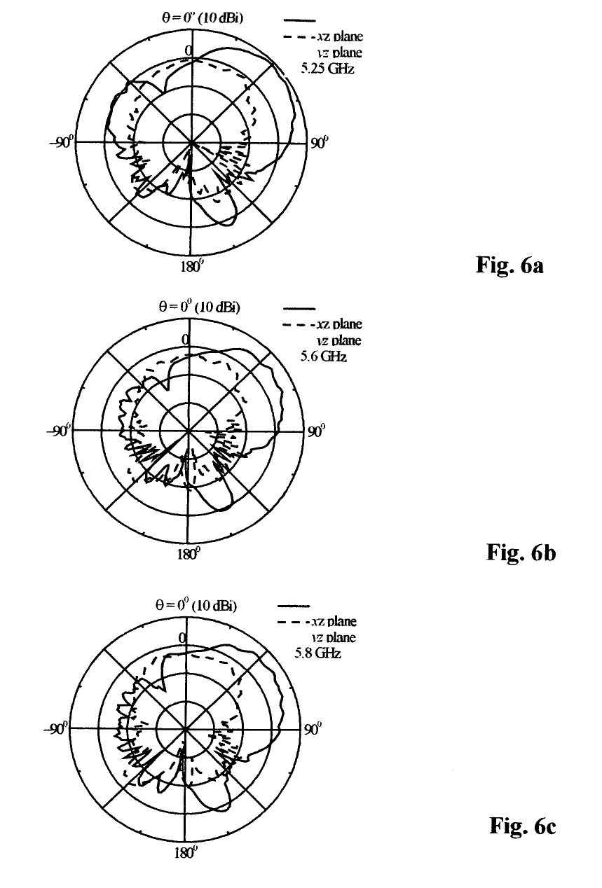

FIGS. 6a to 6c are graphs showing measured radiating patterns of electromagnetic waves generated by the antenna 100 in the xz-plane and yz-plane at 5.25 GHz, 5.6 GHz, and 5.8 GHz respectively. FIGS. 6a to 6c also show stable radiating patterns across a broad bandwidth. The peak gain is found to be greater than 6 dBi in the xz-plane.

Specifically, the gain is dependent on the size of the ground plane 110 while the antenna 100 has a 40 to 45° beam-squinting angle from the bore sight due to the asymmetrical structure of the antenna 100. Beam-squinting here refers to a condition where peak gain is found along the z-axis, i.e. θ=0° or bore sight. The maximum squinted beam is conducive to indoor applications, especially when the antenna 100 is to be installed on a ceiling.

The radiator 106, shorting wall 102 and feed plate structure 112 are made of electrically conductive material with low ohmic loss such as copper, brass, sheet metal and aluminum.

The various embodiments of the invention are designed to provide a compact antenna having a broad bandwidth and stable gain. The antenna 100 has low manufacturing cost and is suitable for implementation in portable devices, indoor or outdoor access points and MIMO applications that employs WiMAX, WLAN, WiFi, and UWB standards.

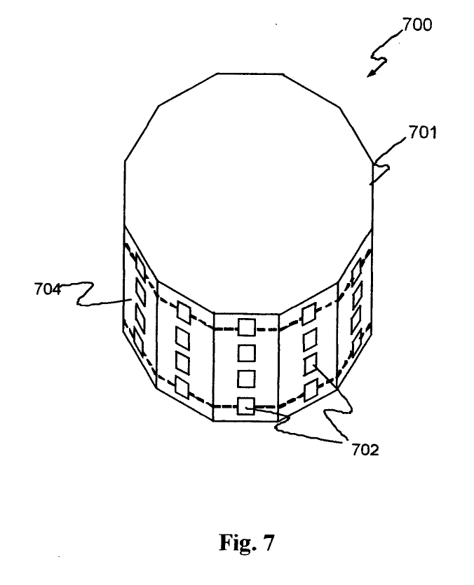

FIG. 7 shows an antenna array 700 for providing an omni-directional coverage in a desired plane. The antenna array 700 comprises antenna elements 702 arranged on a body 701 having twelve sides 702. Each of the twelve sides 102 of the body 701 has at least one and preferably four antenna elements 702 formed thereon for providing omni-directional coverage in that side.

More specifically, the foregoing antenna 100 is used as the antenna element 702 of the antenna array 700. Each antenna element 702 has a directional pattern that covers a certain sector. The use of a twelve-sector antenna array 700 is to ensure that the antenna array 700 has omni-directional coverage in a desired plane and substantially reducing blind spots, for example in the azimuth plane.

With reference to FIG. 7, there are multiple antenna elements 702 in each sector 704 of the twelve-sector antenna array 700 for MIMO applications. The use of the antenna 100 as the antenna element 702 advantageously reduces the overall size of the antenna array 700 and allows the antenna array 700 to have a more compact design.

Additionally, the configuration of each of the antenna elements 702 in the antenna array 700 provides the antenna array 700 with well-matched impedance response and a gain of more than 5 dBi. The antenna array 700 also provides a stable radiation performance across the entire WiFi and WiMAX bandwidths of 5.15 to 5.875 GHz and 5.725 to 5.875 GHz respectively. Given the compact size of the antenna array 700, the mutual coupling between adjacent antenna elements 702 is significant and therefore requires suppression. The mutual coupling between adjacent antenna elements 702 of the antenna array 700 is reduced to less than −15 dB.

In the foregoing manner, an antenna having a feed plate structure for wireless communications is disclosed. Although only a number of embodiments of the invention are disclosed, it becomes apparent to one skilled in the art in view of this disclosure that numerous changes and/or modifications can be made without departing from the scope and spirit of the invention.

1. An antenna formable on a ground plane for wireless communications, the antenna comprising:
a first structure spatially displaced from a ground plane;
a second structure coupled to the first structure and extending away from the ground plane; and
a third structure configured for disposing at least a portion of the first structure between the third structure and the ground plane, the third structure being grounded to the ground plane and being spatially displaced from the second structure, the second structure and the third structure being inter-configured for electromagnetic coupling therebetween for forming a magnetic loop,
wherein electromagnetic field generated by the first structure and the second structure electromagnetically couples the third structure for inducing generation of broadband electromagnetic waves from the first, second and third structures.

2. The antenna as in claim 1, further comprising a fourth structure extending from and for grounding the third structure to the ground plane.

3. The antenna as in claim 1, the first structure being substantially a plate structure extending substantially parallel the ground plane.

4. The antenna as in claim 3, at least a portion of the second structure being substantially a plate structure extending from the first structure and away from the ground plane.

5. The antenna as in claim 4, the first structure intersects the second structure at the edge thereof.

6. The antenna as in claim 4, the first structure being substantially perpendicular to the second structure.

7. The antenna as in claim 1, the third structure being substantially a plate structure extending substantially parallel the ground plane.

8. The antenna as in claim 7, further comprising:
a fourth structure extending from an edge of the third structure and for grounding the third structure to the ground plane.

9. The antenna as in claim 1, the second structure having a rectilinear shape.

10. The antenna as in claim 1, the second structure comprising a plurality of plates sequentially inter-coupled.

11. A method for configuring an antenna formable on a ground plane for wireless communications, the method comprising:
spatially displacing a first structure from a ground plane;
coupling a second structure to the first structure and extending the second structure away from the ground plane; and
configuring a third structure for disposing at least a portion of the first structure between the third structure and the ground plane, the third structure being grounded to the ground plane and being spatially displaced from the second structure, the second structure and the third structure being inter-configured for electromagnetic coupling therebetween for forming a magnetic loop,
wherein electromagnetic field generated by the first structure and the second structure electromagnetically couples the third structure for inducing generation of broadband electromagnetic waves from the first, second and third structures.

12. The method as in claim 11, further comprising extending a fourth structure from and for grounding the third structure to the ground plane.

13. The method as in claim 1, the first structure being substantially a plate structure extending substantially parallel the ground plane.

14. The method as in claim 13, at least a portion of the second structure being substantially a plate structure extending from the first structure and away from the ground plane.

15. The method as in claim 14, the first structure intersects the second structure at the edge thereof.

16. The method as in claim 14, the first structure being substantially perpendicular to the second structure.

17. The method as in claim 11, the third structure being substantially a plate structure extending substantially parallel the ground plane.

18. The method as in claim 17, further comprising:
extending a fourth structure from an edge of the third structure and for grounding the third structure to the ground plane.

19. The method as in claim 11, the second structure having a rectilinear shape.

20. The method as in claim 11, the second structure comprising a plurality of plates sequentially inter-coupled.

21. An antenna array for wireless communications, the antenna array comprising:
a body having a plurality of surfaces; and
a plurality of antenna formed on the surfaces of the body; each of the plurality of antenna comprising:
a first structure spatially displaced from a ground plane;
a second structure coupled to the first structure and extending away from the ground plane; and
a third structure configured for disposing at least a portion of the first structure between the third structure and the ground plane, the third structure being grounded to the ground plane and being spatially displaced from the second structure, the second structure and the third structure being inter-configured for electromagnetic coupling therebetween for forming a magnetic loop,
wherein electromagnetic field generated by the first structure and the second structure electromagnetically couples the third structure for inducing generation of broadband electromagnetic waves from the first, second and third structures.
